(19) United States
(12) Patent Application Publication
(10) Pub. No.: US 2021/0402976 A1
(43) Pub. Date: Dec. 30, 2021

(54) Method of Controlling Generator for Vehicle

(71) Applicants: Hyundai Motor Company, Seoul (KR); Kia Motors Corporation, Seoul (KR)

(72) Inventors: Dae Kwang Kim, Yongin-si (KR); Young Ho Jung, Seoul (KR); SangJae Han, Hwaseong-si (KR); Sung Tae Kim, Seoul (KR)

(21) Appl. No.: 17/104,199

(22) Filed: Nov. 25, 2020

(30) Foreign Application Priority Data
Jun. 24, 2020 (KR) 10-2020-0077344

(51) Int. Cl. B60W 20/14; B60L 7/20; B60W 10/18; B60W 10/26; B60L 53/24; G01C 21/34

(52) U.S. Cl. CPC B60W 20/14; B60L 7/20; G01C 21/3469; B60W 10/26; B60L 53/24; B60W 10/18

(57) ABSTRACT

A method of controlling a generator for a vehicle includes calculating a current charging amount and a target charging amount of a battery, estimating regenerative energy of the battery based on predicted vehicle travel information, and determining whether a road section in which the vehicle travels is a regenerative braking section based on the predicted vehicle travel information and vehicle position information. The generator and the battery are controlled so the generator maximally charges the battery when the road section in which the vehicle travels is the regenerative braking section and so the energy of the battery and a charging amount of the battery is the target charging amount when the road section in which the vehicle travels is not the regenerative braking section.

### CROSS-REFERENCE TO RELATED APPLICATIONS

This application claims priority to Korean Patent Application No. 10-2020-0077344, filed in the Korean Intellectual Property Office on Jun. 24, 2020, which application is hereby incorporated herein by reference.

### TECHNICAL FIELD

The present invention relates to a method of controlling a generator for a vehicle.

### BACKGROUND

A hybrid electric vehicle uses both an internal combustion engine and battery power. That is, the hybrid electric vehicle efficiently combines and uses power from an internal combustion engine and power from a motor.

The hybrid electric vehicles may be classified into a mild type hybrid electric vehicle and a hard type hybrid electric vehicle depending on a distribution ratio between the power from the engine and the power from the motor. The mild type hybrid electric vehicle (or mild hybrid electric vehicle) includes an MHSG (mild hybrid starter & generator), which starts the engine or generates electric power using an output from the engine, instead of an alternator. The hard type hybrid electric vehicle separately includes a starter-generator configured to start the engine or generate electric power using an output from the engine, and a drive motor configured to operate the vehicle.

There is no traveling mode in which the mild hybrid electric vehicle is operated only by torque of the MHSG. However, the MHSG may be used to supplement engine torque in accordance with a traveling state, and a battery (e.g., a 48 V battery) may be charged by regenerative braking. Therefore, fuel economy of the mild hybrid electric vehicle may be improved.

A battery, which serves to supply power to various types of electrical devices installed in the vehicle, is mounted in the vehicle such as the mild hybrid electric vehicle. The single battery is typically installed in the vehicle, and the generator operates in accordance with a state of charge of the battery in order to charge the battery.

Meanwhile, some vehicles are mounted with a plurality of batteries in order to increase overall capacities of the batteries and operate such that when any one battery has a problem, another battery supplies power.

For example, a dual battery device having two batteries controls circuit connection between the two batteries when the vehicle is initially started. The dual battery device with an increased battery capacity may supply power to a vehicle having an electrical device for an autonomous driving vehicle or a plurality of electrical devices (or electronic devices).

The above information disclosed in this Background section is only for enhancement of understanding of the background of the invention and therefore it may contain information that does not form the prior art that is already known in this country to a person of ordinary skill in the art.

### SUMMARY

Embodiments of the present invention provide a method of controlling a generator for a vehicle, which is capable of using predicted vehicle travel information to efficiently manage a charging amount of a battery that supplies power to a starter and electrical loads of the vehicle.

An exemplary embodiment of the present invention provides a method of controlling a generator for a vehicle. A controller calculates a current charging amount and a target charging amount of a battery configured to supply power to a starter and electrical loads of the vehicle. The controller estimates regenerative energy of the battery based on predicted vehicle travel information and determines whether a road section in which the vehicle travels is a regenerative braking section based on the predicted vehicle travel information and vehicle position information. The controller controls the generator and the battery so that a charging amount of the battery does not exceed the target charging amount and the generator of the vehicle maximally charges the battery when the road section in which the vehicle travels is the regenerative braking section. The controller controls the generator and the battery based on required charging energy of the battery and the regenerative energy of the battery so that the charging amount of the battery is the target charging amount when the road section in which the vehicle travels is not the regenerative braking section.

The method of controlling a generator for a vehicle may further include determining, by the controller, whether the required charging energy of the battery exceeds the regenerative energy of the battery when the road section in which the vehicle travels is not the regenerative braking section, in which when the required charging energy of the battery is equal to or lower than the regenerative energy of the battery, the controller controls the generator and the battery so that the charging amount of the battery is maintained as the target charging amount and power of the battery is discharged to the electrical loads.

The controller may calculate the required charging energy of the battery by subtracting the current charging amount of the battery from the target charging amount of the battery.

The method of controlling a generator for a vehicle may further include determining, by the controller, whether the road section in which the vehicle travels is a constant-speed travel section based on the predicted vehicle travel information and the vehicle position information when the required charging energy of the battery exceeds the regenerative energy of the battery, in which when the road section in which the vehicle travels is the constant-speed travel section, the controller controls an engine of the vehicle, the generator connected to the engine, and the battery so that the charging amount of the battery is the target charging amount.

When a speed of the vehicle detected by a vehicle speed sensor of the vehicle is within a reference speed range and a variation value of an accelerator opening amount detected by an accelerator pedal detector of the vehicle is within a reference variation value range, the controller may determine that the road section in which the vehicle travels is the constant-speed travel section of the vehicle.

Another exemplary embodiment of the present invention provides a method of controlling a generator for a vehicle. A controller calculates current charging amounts and target charging amounts of first and second batteries configured to supply power to a starter and electrical loads of the vehicle. The controller estimates regenerative energy of the first battery and regenerative energy of the second battery based on predicted vehicle travel information. The controller determines whether a road section in which the vehicle travels is a regenerative braking section based on the predicted vehicle travel information and vehicle position information. The controller controls the generator, the first battery, and the second battery so that a charging amount of the first battery does not exceed the target charging amount of the first battery, a charging amount of the second battery does not exceed the target charging amount of the second battery, and the generator of the vehicle maximally charges the first battery and the second battery when the road section in which the vehicle travels is the regenerative braking section. The controller controls the generator, the first battery, and the second battery based on required charging energy of the first battery, required charging energy of the second battery, the regenerative energy of the first battery, and the regenerative energy of the second battery so that the charging amount of the first battery is the target charging amount of the first battery and the charging amount of the second battery is the target charging amount of the second battery when the road section in which the vehicle travels is not the regenerative braking section.

The method of controlling a generator for a vehicle may further include determining, by the controller, whether a sum of the required charging energy of the first battery and the required charging energy of the second battery exceeds a sum of the regenerative energy of the first battery and the regenerative energy of the second battery when the road section in which the vehicle travels is not the regenerative braking section, in which when the sum of the required charging energy of the first battery and the required charging energy of the second battery is equal to or lower than the sum of the regenerative energy of the first battery and the regenerative energy of the second battery, the controller controls the generator, the first battery, and the second battery so that the charging amount of the first battery is maintained as the target charging amount of the first battery, the charging amount of the second battery is maintained as the target charging amount of the second battery, and power of the first battery and power of the second battery are discharged to the electrical loads.

The controller may calculate the required charging energy of the first battery by subtracting the current charging amount of the first battery from the target charging amount of the first battery, and calculate the required charging energy of the second battery by subtracting the current charging amount of the second battery from the target charging amount of the second battery.

The method of controlling a generator for a vehicle may further include determining, by the controller, whether the road section in which the vehicle travels is a constant-speed travel section based on the predicted vehicle travel information and the vehicle position information when the sum of the required charging energy of the first battery and the required charging energy of the second battery exceeds the sum of the regenerative energy of the first battery and the regenerative energy of the second battery, in which when the road section in which the vehicle travels is the constant-speed travel section, the controller controls an engine of the vehicle, the generator connected to the engine, the first battery, and the second battery so that the charging amount of the first battery is the target charging amount of the first battery and the charging amount of the second battery is the target charging amount of the second battery.

When a speed of the vehicle detected by a vehicle speed sensor of the vehicle is within a reference speed range and a variation value of an accelerator opening amount detected by an accelerator pedal detector of the vehicle is within a reference variation value range, the controller may determine that the road section in which the vehicle travels is the constant-speed travel section of the vehicle.

Still another exemplary embodiment of the present invention provides a method of controlling a generator for a vehicle. A controller calculates current charging amounts and target charging amounts of first and second batteries configured to supply power to a starter and electrical loads of the vehicle. The controller selects one of the first battery and the second battery, which has a small current charging amount, as a control battery to be controlled. The controller estimates regenerative energy of the control battery based on predicted vehicle travel information and determines whether a road section in which the vehicle travels is a regenerative braking section based on the predicted vehicle travel information and vehicle position information. The controller controls the generator and the control battery so that a charging amount of the control battery does not exceed the target charging amount of the control battery and the generator of the vehicle maximally charges the control battery when the road section in which the vehicle travels is the regenerative braking section. The controller controls the generator and the control battery based on required charging energy of the control battery and the regenerative energy of the control battery so that the charging amount of the control battery is the target charging amount of the control battery when the road section in which the vehicle travels is not the regenerative braking section.

The method of controlling a generator for a vehicle may further include determining, by the controller, whether the required charging energy of the control battery exceeds the regenerative energy of the control battery when the road section in which the vehicle travels is not the regenerative braking section, in which when the required charging energy of the control battery is equal to or lower than the regenerative energy of the control battery, the controller controls the generator and the control battery so that the charging amount of the control battery is maintained as the target charging amount of the control battery and power of the control battery is discharged to the electrical loads.

The controller may calculate the required charging energy of the control battery by subtracting the current charging amount of the control battery from the target charging amount of the control battery.

The method of controlling a generator for a vehicle may further include determining, by the controller, whether the road section in which the vehicle travels is a constant-speed travel section based on the predicted vehicle travel information and the vehicle position information when the required charging energy of the control battery exceeds the regenerative energy of the control battery, in which when the road section in which the vehicle travels is the constant-speed travel section, the controller controls an engine of the vehicle, the generator connected to the engine, and the control battery so that the charging amount of the control battery is the target charging amount of the control battery.

When a speed of the vehicle detected by a vehicle speed sensor of the vehicle is within a reference speed range and a variation value of an accelerator opening amount detected by an accelerator pedal detector of the vehicle is within a reference variation value range, the controller may determine that the road section in which the vehicle travels is the constant-speed travel section of the vehicle.

The method of controlling a generator for a vehicle according to the exemplary embodiment of the present invention may improve durability of the battery and fuel economy of the vehicle by using the predicted vehicle travel information to maintain a predetermined optimum level or a higher level of a charging amount or a state of charge (charging energy) of the battery that supplies power to the starter and the electrical loads of the vehicle.

### BRIEF DESCRIPTION OF THE DRAWINGS

The brief description of the drawings is provided to more sufficiently understand the drawings used in the detailed description of the present invention.

FIG. 1 is a flowchart for explaining a method of controlling a generator for a vehicle according to an exemplary embodiment of the present invention.

FIG. 2 is a block diagram for explaining a device for controlling a generator for a vehicle to which the method of controlling a generator for a vehicle illustrated in FIG. 1 is applied.

FIG. 3 is a graph for explaining an example of a driving course of a vehicle illustrated in FIG. 1.

FIG. 4 is a flowchart for explaining a method of controlling a generator for a vehicle according to another exemplary embodiment of the present invention.

FIG. 5 is a block diagram for explaining a device for controlling a generator for a vehicle to which the method of controlling a generator for a vehicle illustrated in FIG. 4 is applied.

FIG. 6 is a flowchart for explaining a method of controlling a generator for a vehicle according to still another exemplary embodiment of the present invention.

FIG. 7 is a block diagram for explaining a device for controlling a generator for a vehicle to which the method of controlling a generator for a vehicle illustrated in FIG. 6 is applied.

The following reference numerals can be used in conjunction with the drawings:
200: Controller
205: Navigation device
210: Engine
215: Generator
225: Battery
400: Controller
405: Navigation device
410: Engine
415: Generator
425: First battery
435: Second battery
600: Controller
605: Navigation device
610: Engine
615: Generator
630: First battery
640: Second battery

### DETAILED DESCRIPTION OF ILLUSTRATIVE EMBODIMENTS

In order to sufficiently understand the present invention and the object to be achieved by carrying out the present invention, reference needs to be made to the accompanying drawings for illustrating exemplary embodiments of the present invention and contents disclosed in the accompanying drawings.

Hereinafter, the exemplary embodiments of the present invention will be described in detail with reference to the accompanying drawings. In the description of the present invention, the specific descriptions of publicly known related configurations or functions will be omitted when it is determined that the specific descriptions may obscure the subject matter of the present invention. Like reference numerals indicated in the respective drawings may refer to like components.

The terms used in the present specification are used only for the purpose of describing particular exemplary embodiments and are not intended to limit the present invention. Singular expressions include plural expressions unless clearly described as different meanings in the context. In the present specification, it should be understood that the terms “comprises,” “comprising,” “includes,” “including,” “containing,” “has,” “having” or other variations thereof are inclusive and therefore specify the presence of stated features, integers, steps, operations, elements, components, or combinations thereof, but do not preclude the presence or addition of one or more other features, integers, steps, operations, elements, components, or combinations thereof.

Throughout the present specification, when one constituent element is referred to as being “connected to” another constituent element, one constituent element can be “directly connected to” the other constituent element, and one constituent element can also be “electrically or mechanically connected to” the other constituent element with other constituent elements therebetween.

Unless otherwise defined, the terms used herein, including technical or scientific terms, have the same meaning as commonly understood by those skilled in the art to which the present invention pertains. The terms such as those defined in a commonly used dictionary should be interpreted as having meanings consistent with meanings in the context of related technologies and should not be interpreted as ideal or excessively formal meanings unless explicitly defined in the present specification.

An engine control unit (ECU) of a vehicle according to the related technology uses state information of a battery to control the voltage of a generator (alternator), thereby controlling or managing a charging amount of the battery that supplies power to a starter and electrical loads of the vehicle.

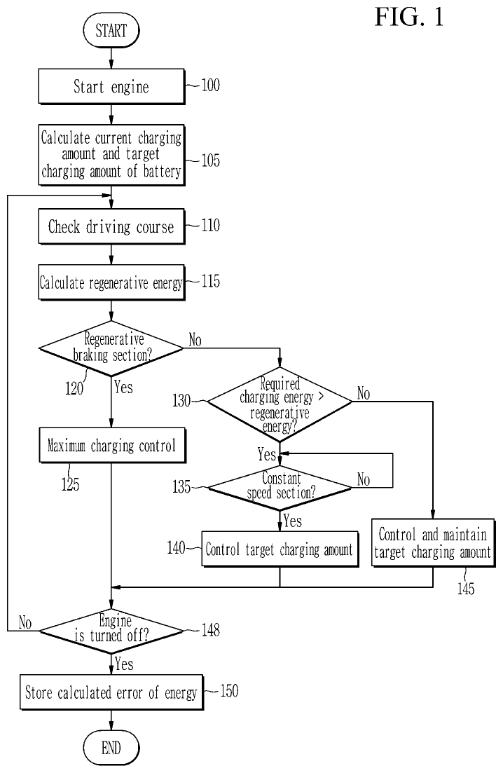

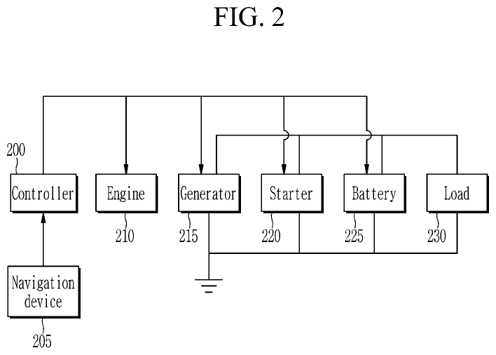

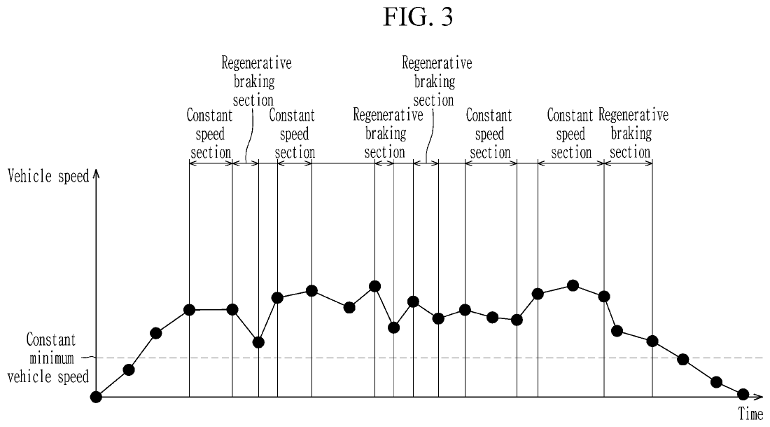

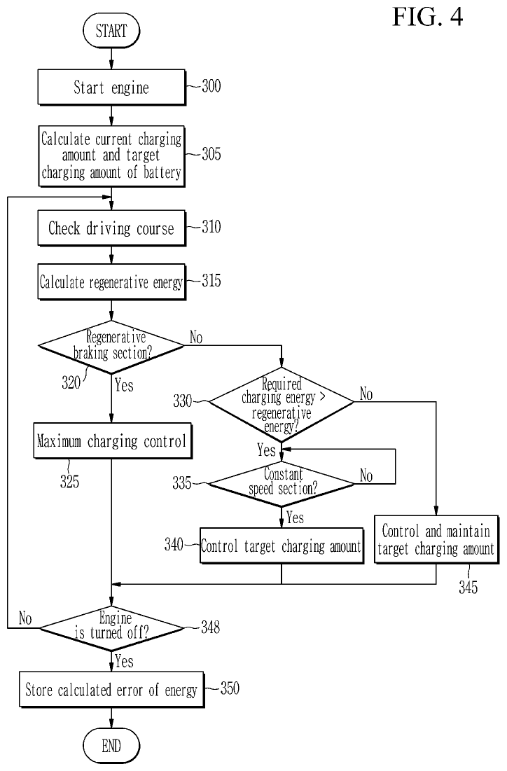

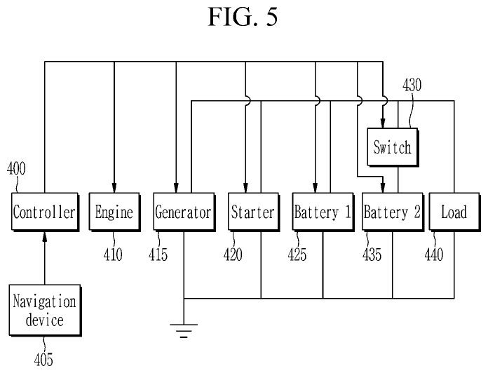

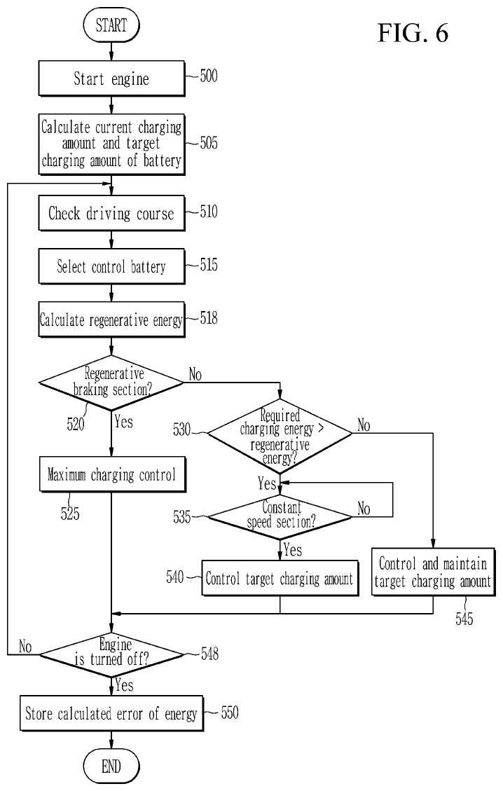

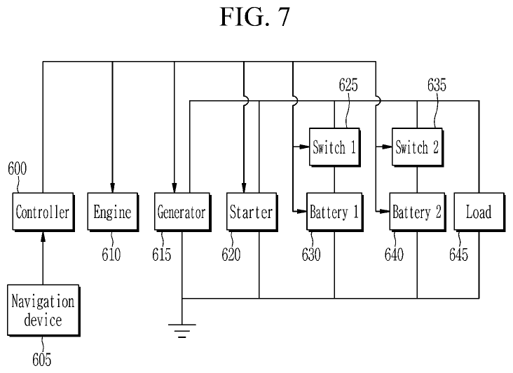

FIG. 1 is a flowchart for explaining a method of controlling a generator for a vehicle according to an exemplary embodiment of the present invention. FIG. 2 is a block diagram for explaining a device for controlling a generator for a vehicle to which the method of controlling a generator for a vehicle illustrated in FIG. 1 is applied. FIG. 3 is a graph for explaining an example of a driving course of a vehicle illustrated in FIG. 1. FIG. 4 is a flowchart for explaining a method of controlling a generator for a vehicle according to another exemplary embodiment of the present invention. FIG. 5 is a block diagram for explaining a device for controlling a generator for a vehicle to which the method of controlling a generator for a vehicle illustrated in FIG. 4 is applied. FIG. 6 is a flowchart for explaining a method of controlling a generator for a vehicle according to still another exemplary embodiment of the present invention. FIG. 7 is a block diagram for explaining a device for controlling a generator for a vehicle to which the method of controlling a generator for a vehicle illustrated in FIG. 6 is applied.

Referring to FIGS. 1 to 3, in starting step too, a controller 200 may operate a starter 220 in response to a request of a driver in a vehicle, thereby starting an engine 210 of the vehicle such as a mild hybrid electric vehicle.

As illustrated in FIG. 2, the device for controlling a generator for a vehicle may include the controller 200, a navigation device 205, the engine 210 such as a diesel engine or a gasoline engine, a generator (or alternator) 215, and a battery 225 configured to supply power to the starter 220 and electrical loads 230 of the vehicle. For example, the electrical load 230 may be a head lamp or an air conditioner, and the battery 225 may be a lead-acid battery or a lithium battery.

The controller 200 is an electronic control unit (ECU) capable of controlling all operations of the vehicle. For example, the controller 200 may be one or more microprocessors operated by a program (control logic) or hardware (e.g., a microcomputer) including the microprocessor, and the program may include a series of instructions for performing the method of controlling a generator for a vehicle according to the exemplary embodiment of the present invention. The instruction may be stored in a memory of the vehicle.

According to step 105 illustrated in FIG. 1, the controller 200 may calculate a current charging amount (or current charging energy) of the battery 225 and calculate a target charging amount (or target charging energy). For example, the controller 200 may calculate the current charging amount of the battery 225 by using a signal from a sensor that detects the charging amount of the battery 225.

The target charging amount is a value for maintaining a predetermined level (e.g., 60% or more) or a higher level of a state of charge (SOC) of the battery 225 and may vary depending on characteristics and temperatures of the battery. The target charging amount of the battery 225 may be increased as the electrical loads 230 include a dashboard camera.

According to step 110, the controller 200 may check a driving course of the vehicle based on predicted vehicle travel information transmitted from the navigation device 205. An example of the driving course is illustrated in FIG. 3.

The navigation device 205 receives road information and transport information from a server of an intelligent transport system (ITS) or a telematics server installed (positioned) outside the vehicle, generates the predicted vehicle travel information, and provides or transmits the predicted travel information to the controller 200.

The predicted vehicle travel information may include information about a route to a destination of the vehicle which is inputted by the driver. The road information may include a gradient and a curvature of a road and a speed limit on a road. The navigation device 205 may include a global positioning system (GPS) receiver that generates vehicle position information.

According to step 115, after step 110, based on the predicted vehicle travel information, the controller 200 may estimate or calculate regenerative energy (or regenerative braking energy) which is generated by the generator 215 in a regenerative braking section of the vehicle illustrated in FIG. 3 and then stored in the battery 225. According to another exemplary embodiment of the present invention, the controller 200 may calculate the regenerative energy corresponding to the previous travel information identical to the predicted vehicle travel information by removing an error caused by the predicted travel information. The error is stored in the memory.

The regenerative braking may mean a process of recovering braking energy, which is generated when the vehicle travels while being braked, by the power generation of the generator 215 connected to the engine 210 of the vehicle, and then charging the battery 225 with the recovered braking energy.

According to step 120, based on the predicted vehicle travel information and the vehicle position information, the controller 200 may determine whether a road section in which the vehicle travels is the regenerative braking section (a fuel cut-off section in which a supply of fuel to the engine 210 is cut off or a speed reduction section of the vehicle, such as a downhill road or a curved road).

When the road section in which the vehicle travels is the regenerative braking section, the process of the method of controlling a generator for a vehicle may go to step 125, and when the road section in which the vehicle travels is not the regenerative braking section, the process of the method of controlling a generator for a vehicle may go to step 130.

According to step 125, the controller 200 may control the generator (or the voltage of the generator) and the battery so that the generator 215 charges the battery 225 maximally (i.e., 100%).

According to step 130, the controller 200 may determine whether required charging energy of the battery 225 exceeds the regenerative energy of the battery. For example, the controller 200 may calculate the required charging energy of the battery by subtracting the current charging amount of the battery from the target charging amount of the battery 225.

When the required charging energy of the battery 225 is higher than the regenerative energy of the battery, the process of the method of controlling a generator for a vehicle may go to step 135, and when the required charging energy of the battery 225 is equal to or lower than the regenerative energy of the battery, the process of the method of controlling a generator for a vehicle may go to step 145.

According to step 145, the controller 200 may control the generator 215 and the battery 225 so that the charging amount of the battery 225 is maintained as the target charging amount and the power of the battery 225 is discharged to the electrical loads 230.

According to step 135, based on the predicted vehicle travel information and the vehicle position information, the controller 200 may determine whether the road section in which the vehicle travels is a constant-speed travel (cruise travel) section of the vehicle. The constant-speed travel section may mean a section or a region in which a speed of the vehicle is within a predetermined speed range and a variation value of an accelerator opening amount detected by an accelerator pedal detector of the vehicle is within a predetermined value range. Therefore, when the speed of the vehicle detected by a vehicle speed sensor of the vehicle is within a reference speed range and the variation value of the accelerator opening amount detected by the accelerator pedal detector of the vehicle is within a reference variation value range, the controller 200 may ascertain (determine) that the road section in which the vehicle travels is the constant-speed travel section of the vehicle.

According to step 140, when the road section in which the vehicle travels is the constant-speed travel (cruise travel) section of the vehicle, the controller 200 may control the engine 210, the generator 215 connected to the engine, and the battery 225 so that the charging amount of the battery 225 becomes the target charging amount. In addition, the controller 200 may control the engine 210, the generator 215 connected to the engine, and the battery 225 so that the battery 225 is charged with a power amount corresponding to energy made by subtracting the regenerative energy of the battery from the required charging energy of the battery 225.

According to step 148, after steps 125, 140, and 145, the controller 200 may determine whether the engine 210 is turned off.

When the engine 210 is turned off, the process of the method of controlling a generator for a vehicle may go to step 150, and when the engine is not turned off, the process of the method of controlling a generator for a vehicle may go to step 110.

According to step 150, with the use of the sensor for detecting the charging amount of the battery 225, the controller 200 may detect (or measure) actual regenerative energy of the battery 225, calculate an error between the actual regenerative energy of the battery 225 and the estimated regenerative energy of the battery, and store the calculated error in the memory. The error may be generated due to the predicted vehicle travel information.

In another exemplary embodiment of the present invention, the step 150 may be omitted.

Referring to FIGS. 3 to 5, in starting step 300, a controller 400 may operate a starter 420 in response to a request of a driver in a vehicle, thereby starting an engine 410 of the vehicle.

As illustrated in FIG. 5, the device for controlling a generator for a vehicle may include the controller 400, a navigation device 405, the engine 410 such as a diesel engine or a gasoline engine, a generator (or alternator) 415, and first and second batteries 425 and 435 configured to supply power to the starter 420 and electrical loads 440 of the vehicle. For example, the electrical load 440 may be a head lamp or an air conditioner, the first battery 425 may be a lead-acid battery, and the second battery 435 may be a lithium battery.

The controller 400 is an electronic control unit (ECU) capable of controlling all operations of the vehicle. For example, the controller 400 may be one or more microprocessors operated by a program (control logic) or hardware (e.g., a microcomputer) including the microprocessor, and the program may include a series of instructions for performing the method of controlling a generator for a vehicle according to the exemplary embodiment of the present invention. The instruction may be stored in a memory of the vehicle.

According to step 305 illustrated in FIG. 4, the controller 400 may calculate a current charging amount and a target charging amount of the first battery 425 and a current charging amount and a target charging amount of the second battery 435. For example, the controller 400 may calculate a current charging amount of the first battery 425 or the second battery 435 by using a signal from a sensor that detects a charging amount of the first battery 425 or the second battery 435.

The target charging amount is a value for maintaining a predetermined level (e.g., 60% or more) or a higher level of a state of charge (SOC) of each of the first battery 425 and the second battery 435 and may vary depending on characteristics and temperatures of the first battery and characteristics and temperatures of the second battery. The target charging amounts of the first battery 425 and the second battery 435 may be increased as the electrical loads 440 include a dashboard camera.

According to step 310, the controller 400 checks a driving course of the vehicle based on predicted vehicle travel information transmitted from the navigation device 405. An example of the driving course is illustrated in FIG. 3.

The navigation device 405 receives road information and transport information from a server of an intelligent transport system (ITS) or a telematics server installed (positioned) outside the vehicle, generates the predicted vehicle travel information, and provides or transmits the predicted travel information to the controller 400.

The predicted vehicle travel information may include information about a route to a destination of the vehicle which is inputted by the driver. The road information may include a gradient and a curvature of a road and a speed limit on a road. The navigation device 405 may include a global positioning system (GPS) receiver that generates vehicle position information.

According to step 315, after step 310, based on the predicted vehicle travel information, the controller 400 may estimate or calculate regenerative energy (or regenerative braking energy) which is generated by the generator 415 in a regenerative braking section of the vehicle illustrated in FIG. 3 and then stored in the first battery 425 and the second battery 435. According to another exemplary embodiment of the present invention, the controller 400 may calculate the regenerative energy corresponding to the previous travel information identical to the predicted vehicle travel information by removing an error caused by the predicted travel information. The error is stored in the memory.

The regenerative braking may mean a process of recovering braking energy, which is generated when the vehicle travels while being braked, by the power generation of the generator 415 connected to the engine 410 of the vehicle, and then charging the first battery 425 and the second battery 435 with the recovered braking energy.

According to step 320, based on the predicted vehicle travel information and the vehicle position information, the controller 400 may determine whether the road section in which the vehicle travels is the regenerative braking section.

When the road section in which the vehicle travels is the regenerative braking section, the process of the method of controlling a generator for a vehicle may go to step 325, and when the road section in which the vehicle travels is not the regenerative braking section, the process of the method of controlling a generator for a vehicle may go to step 330.

According to step 325, the controller 400 may control the generator, the first battery, and the second battery so that the generator 415 charges the first battery 425 and the second battery 435 maximally (i.e., 100%). When the first battery 425 and the second battery 435 are charged maximally, the controller 400 may control a switch 430 so that the switch 430 is closed. The second battery 435 may be used when the electrical loads 440 are large.

According to step 330, the controller 400 may determine whether a sum of the required charging energy of the first battery 425 and the required charging energy of the second battery 435 exceeds a sum of the regenerative energy of the first battery and the regenerative energy of the second battery. For example, the controller 400 may calculate the required charging energy of the first battery 425 by subtracting the current charging amount of the first battery from the target charging amount of the first battery 425, and calculate the required charging energy of the second battery 435 by subtracting the current charging amount of the second battery from the target charging amount of the second battery 435.

When the sum of the required charging energy of the first battery 425 and the required charging energy of the second battery 435 is larger than the sum of the regenerative energy of the first battery and the regenerative energy of the second battery, the process of the method of controlling a generator for a vehicle may go to step 335, and when the sum of the required charging energy of the first battery 425 and the required charging energy of the second battery 435 is equal to or lower than the sum of the regenerative energy of the first battery and the regenerative energy of the second battery, the process of the method of controlling a generator for a vehicle may go to step 345.

According to step 345, the controller 400 may control the generator 415, the first battery 425, and the second battery 435 so that the charging amount of the first battery 425 is maintained as the target charging amount of the first battery, the charging amount of the second battery 435 is maintained as the target charging amount of the second battery, the power of the first battery 425 is discharged to the electrical loads 440, and the power of the second battery 435 is discharged to the electrical loads 440. When the power of the second battery 435 is discharged to the electrical loads 440, the controller 400 may control the switch 430 so that the switch 430 is closed.

According to step 335, based on the predicted vehicle travel information and the vehicle position information, the controller 400 may determine whether the road section in which the vehicle travels is a constant-speed travel (cruise travel) section of the vehicle. The constant-speed travel section may mean a section or a region in which a speed of the vehicle is within a predetermined speed range and a variation value of an accelerator opening amount detected by an accelerator pedal detector of the vehicle is within a predetermined value range. Therefore, when the speed of the vehicle detected by a vehicle speed sensor of the vehicle is within a reference speed range and the variation value of the accelerator opening amount detected by the accelerator pedal detector of the vehicle is within a reference variation value range, the controller 400 may ascertain (determine) that the road section in which the vehicle travels is the constant-speed travel section of the vehicle.

According to step 340, when the road section in which the vehicle travels is the constant-speed travel (cruise travel) section of the vehicle, the controller 400 may control the engine 410, the generator 415 connected to the engine, the first battery 425, and the second battery 435 so that the charging amount of the first battery 425 becomes the target charging amount of the first battery and the charging amount of the second battery 435 becomes the target charging amount of the second battery. When the charging amount of the second battery 435 becomes the target charging amount of the second battery, the controller 400 may control the switch 430 so that the switch 430 is closed. The controller 400 may control the engine 410, the generator 415 connected to the engine, the first battery 425, and the second battery 435 so that the first battery 425 is charged with a power amount corresponding to energy made by subtracting the regenerative energy of the first battery from the required charging energy of the first battery 425, and the second battery 435 is charged with a power amount corresponding to energy made by subtracting the regenerative energy of the second battery from the required charging energy of the second battery 435.

According to step 348, after steps 325, 340, and 345, the controller 400 may determine whether the engine 410 is turned off.

When the engine 410 is turned off, the process of the method of controlling a generator for a vehicle may go to step 350, and when the engine is not turned off, the process of the method of controlling a generator for a vehicle may go to step 310.

According to step 350, with the use of the sensor for detecting the charging amount of the first battery 425, the controller 400 may detect (or measure) actual regenerative energy of the first battery, calculate a first error between the actual regenerative energy of the first battery 425 and the estimated regenerative energy of the first battery, and store the calculated first error in the memory. With the use of the sensor for detecting the charging amount of the second battery 435, the controller 400 may detect (or measure) actual regenerative energy of the second battery, calculate a second error between the actual regenerative energy of the second battery 435 and the estimated regenerative energy of the second battery, and store the calculated second error in the memory. The first error and the second error may be generated due to the predicted vehicle travel information.

In another exemplary embodiment of the present invention, the step 350 may be omitted.

Referring to FIGS. 3, 6, and 7, in starting step 500, a controller 600 may operate a starter 620 in response to a request of a driver in a vehicle, thereby starting an engine 610 of the vehicle.

As illustrated in FIG. 6, the device for controlling a generator for a vehicle may include the controller 600, a navigation device 605, the engine 610 such as a diesel engine or a gasoline engine, a generator (or alternator) 615, and a first battery 630 or a second battery 640 configured to supply power to the starter 620 and electrical loads 645 of the vehicle. For example, the electrical load 645 may be a head lamp or an air conditioner, the first battery 630 may be a lead-acid battery, and the second battery 640 may be a lithium battery.

The controller 600 is an electronic control unit (ECU) capable of controlling all operations of the vehicle. For example, the controller 600 may be one or more microprocessors operated by a program (control logic) or hardware (e.g., a microcomputer) including the microprocessor, and the program may include a series of instructions for performing the method of controlling a generator for a vehicle according to the exemplary embodiment of the present invention. The instruction may be stored in a memory of the vehicle.

According to step 505 illustrated in FIG. 6, the controller 600 may calculate a current charging amount and a target charging amount of the first battery 630 and a current charging amount and a target charging amount of the second battery 640. For example, the controller 600 may calculate a current charging amount of the first battery 630 or the second battery 640 by using a signal from a sensor that detects a charging amount of the first battery 630 or the second battery 640.

The target charging amount is a value for maintaining a predetermined level (e.g., 60% or more) or a higher level of a state of charge (SOC) of each of the first battery 630 and the second battery 640 and may vary depending on characteristics and temperatures of the first battery and characteristics and temperatures of the second battery. The target charging amounts of the first battery 630 and the second battery 640 may be increased as the electrical loads 645 include a dashboard camera.

According to step 510, the controller 600 may check a driving course of the vehicle based on predicted vehicle travel information transmitted from the navigation device 605. An example of the driving course is illustrated in FIG. 3.

The navigation device 605 receives road information and transport information from a server of an intelligent transport system (ITS) or a telematics server installed (positioned) outside the vehicle, generates the predicted vehicle travel information, and provides or transmits the predicted travel information to the controller 600.

The predicted vehicle travel information may include information about a route to a destination of the vehicle which is inputted by the driver. The road information may include a gradient and a curvature of a road and a speed limit on a road. The navigation device 605 may include a global positioning system (GPS) receiver that generates vehicle position information.

According to step 515, the controller 600 may select, as a control battery to be controlled, one of the first battery 630 and the second battery 640, which has a small current charging amount. In another exemplary embodiment of the present invention, the controller 600 may select, as the control battery to be controlled, one of the first battery 630 and the second battery 640 which has a high aging degree (i.e., a low state of health). The controller 600 may measure the aging degree by measuring the number of times the battery is charged and discharged, or the controller 600 may measure the aging degree by using a well-known technology. When the battery has a large value of the aging degree, this means that a lifespan of the battery is relatively highly shortened.

According to step 518, after step 515, based on the predicted vehicle travel information, the controller 600 may estimate or calculate regenerative energy (or regenerative braking energy) which is generated by the generator 615 in a regenerative braking section of the vehicle illustrated in FIG. 3 and then stored in the control battery. According to another exemplary embodiment of the present invention, the controller 600 may calculate the regenerative energy corresponding to the previous travel information identical to the predicted vehicle travel information by removing an error caused by the predicted travel information. The error is stored in the memory.

The regenerative braking may mean a process of recovering braking energy, which is generated when the vehicle travels while being braked, by the power generation of the generator 615 connected to the engine 610, and then charging the control battery with the recovered braking energy.

According to step 520, based on the predicted vehicle travel information and the vehicle position information, the controller 600 may determine whether the road section in which the vehicle travels is the regenerative braking section.

When the road section in which the vehicle travels is the regenerative braking section, the process of the method of controlling a generator for a vehicle may go to step 525, and when the road section in which the vehicle travels is not the regenerative braking section, the process of the method of controlling a generator for a vehicle may go to step 530.

According to step 525, the controller 600 may control the generator and the control battery so that the generator 615 charges the control battery maximally (i.e., 100%). When the control battery is charged maximally, the controller 600 may control the first and second switches 625 and 635 so that one of the first and second switches 625 and 635, which corresponds to the control battery, is closed.

According to step 530, the controller 600 may determine whether required charging energy of the control battery exceeds the regenerative energy of the control battery. For example, the controller 600 may calculate the required charging energy of the control battery by subtracting the current charging amount of the control battery from the target charging amount of the control battery.

When the required charging energy of the control battery is higher than the regenerative energy of the control battery, the process of the method of controlling a generator for a vehicle may go to step 535, and when the required charging energy of the control battery is equal to or lower than the regenerative energy of the control battery, the process of the method of controlling a generator for a vehicle may go to step 545.

According to step 545, the controller 600 may control the generator 615 and the control battery so that the charging amount of the control battery is maintained as the target charging amount of the control battery and the power of the control battery is discharged to the electrical loads 645. When the power of the control battery is discharged to the electrical loads 645, the controller 600 may control the first and second switches 625 and 635 so that one of the first and second switches 625 and 635, which corresponds to the control battery, is closed.

According to step 535, based on the predicted vehicle travel information and the vehicle position information, the controller 600 may determine whether the road section in which the vehicle travels is a constant-speed travel (cruise travel) section of the vehicle. The constant-speed travel section may mean a section or a region in which a speed of the vehicle is within a predetermined speed range and a variation value of an accelerator opening amount detected by an accelerator pedal detector of the vehicle is within a predetermined value range. Therefore, when the speed of the vehicle detected by a vehicle speed sensor of the vehicle is within a reference speed range and the variation value of the accelerator opening amount detected by the accelerator pedal detector of the vehicle is within a reference variation value range, the controller 600 may ascertain (determine) that the road section in which the vehicle travels is the constant-speed travel section of the vehicle.

According to step 540, when the road section in which the vehicle travels is the constant-speed travel (cruise travel) section of the vehicle, the controller 600 may control the engine 610, the generator 615 connected to the engine, and the control battery so that the charging amount of the control battery becomes the target charging amount. When the charging amount of the control battery becomes the target charging amount, the controller 600 may control the first and second switches 625 and 635 so that one of the first and second switches 625 and 635, which corresponds to the control battery, is closed. The controller 600 may control the engine 610, the generator 415 connected to the engine, and the control battery so that the control battery is charged with a power amount corresponding to energy made by subtracting the regenerative energy of the control battery from the required charging energy of the control battery.

According to step 548, after steps 525, 540, and 545, the controller 600 may determine whether the engine 610 is turned off.

When the engine 610 is turned off, the process of the method of controlling a generator for a vehicle may go to step 550, and when the engine is not turned off, the process of the method of controlling a generator for a vehicle may go to step 510.

According to step 550, with the use of the sensor for detecting the charging amount of the control battery, the controller 600 may detect actual regenerative energy of the control battery, calculate an error between the actual regenerative energy of the control battery and the estimated regenerative energy of the control battery, and store the calculated error in the memory. The error may be generated due to the predicted vehicle travel information.

In another exemplary embodiment of the present invention, the step 550 may be omitted.

The components, “units”, blocks, or modules used in the exemplary embodiments of the present invention may be implemented in software such as a task, class, sub-routine, process, object, execution thread or program, which is performed on a certain memory area, hardware such as a field programmable gate array (FPGA) or an application specific integrated circuit (ASIC), and/or a combination of the software and the hardware. The components or the units may be included in computer-readable media or some of the components or the units may be dispersed and distributed in a plurality of computers.

As described above, the exemplary embodiments have been described with reference to the drawings and the specification. In this case, specific terms used herein are used only for the purpose of describing the present invention, but not used to limit the meaning or the scope of the present invention disclosed in the claims. Accordingly, those skilled in the art will understand that various modifications of the present invention and other exemplary embodiments equivalent thereto may be implemented. Accordingly, the true technical protection scope of the present invention should be determined by the technical spirit of the appended claims.

What is claimed is:

1. A method of controlling a generator for a vehicle, the method comprising:
calculating a current charging amount and a target charging amount of a battery configured to supply power to a starter and electrical loads of the vehicle;
estimating regenerative energy of the battery based on predicted vehicle travel information;
determining whether a road section in which the vehicle travels is a regenerative braking section based on the predicted vehicle travel information and vehicle position information;
controlling the generator and the battery so that the generator maximally charges the battery when the road section in which the vehicle travels is the regenerative braking section; and
controlling the generator and the battery based on required charging energy of the battery and the regenerative energy of the battery so that a charging amount of the battery is the target charging amount when the road section in which the vehicle travels is not the regenerative braking section.

2. The method of claim 1, further comprising determining whether the required charging energy of the battery exceeds the regenerative energy of the battery when the road section in which the vehicle travels is not the regenerative braking section, wherein when the required charging energy of the battery is equal to or lower than the regenerative energy of the battery, the generator and the battery are controlled so that the charging amount of the battery is maintained as the target charging amount and power of the battery is discharged to the electrical loads.

3. The method of claim 2, further comprising calculating the required charging energy of the battery by subtracting the current charging amount of the battery from the target charging amount of the battery.

4. The method of claim 2, further comprising determining whether the road section in which the vehicle travels is a constant-speed travel section based on the predicted vehicle travel information and the vehicle position information when the required charging energy of the battery exceeds the regenerative energy of the battery, wherein when the road section in which the vehicle travels is the constant-speed travel section wherein an engine of the vehicle, the generator, which is connected to the engine, and the battery are controlled so that the charging amount of the battery is the target charging amount.

5. The method of claim 4, wherein determining whether the road section in which the vehicle travels is a constant-speed travel section comprises determining that the road section in which the vehicle travels is the constant-speed travel section of the vehicle when a speed of the vehicle detected by a vehicle speed sensor of the vehicle is within a reference speed range and a variation value of an accelerator opening amount detected by an accelerator pedal detector of the vehicle is within a reference variation value range.

6. The method of claim 1, further comprising determining the predicted vehicle travel information using a navigation device.

7. The method of claim 1, wherein the vehicle further comprises a second battery configured to supply power to the starter and electrical loads of the vehicle, the second battery having a larger charging amount than the battery.

8. The method of claim 1, wherein the vehicle further comprises a second battery configured to supply power to the starter and electrical loads of the vehicle;
wherein calculating the current charging amount and the target charging amount comprises calculating the current charging amounts and target charging amounts of first and second batteries;
wherein estimating regenerative energy further comprises estimating regenerative energy of the second battery based on predicted vehicle travel information; and
wherein controlling the generator and the battery further comprises controlling the second battery.

9. The method of claim 1, wherein the steps of calculating, estimating, determining and, controlling the generator and the battery are performed by a controller of the vehicle.

10. A method of controlling a generator for a vehicle, the method comprising:
calculating current charging amounts and target charging amounts of first and second batteries configured to supply power to a starter and electrical loads of the vehicle;
estimating regenerative energy of the first battery and regenerative energy of the second battery based on predicted vehicle travel information;
determining whether a road section in which the vehicle travels is a regenerative braking section based on the predicted vehicle travel information and vehicle position information;
controlling the generator, the first battery, and the second battery so that the generator maximally charges the first battery and the second battery when the road section in which the vehicle travels is the regenerative braking section; and
controlling the generator, the first battery, and the second battery based on required charging energy of the first battery, required charging energy of the second battery, the regenerative energy of the first battery, and the regenerative energy of the second battery so that a charging amount of the first battery is the target charging amount of the first battery and a charging amount of the second battery is the target charging amount of the second battery when the road section in which the vehicle travels is not the regenerative braking section.

11. The method of claim 10, further comprising:
determining whether a sum of the required charging energy of the first battery and the required charging energy of the second battery exceeds a sum of the regenerative energy of the first battery and the regenerative energy of the second battery when the road section in which the vehicle travels is not the regenerative braking section,
wherein when the sum of the required charging energy of the first battery and the required charging energy of the second battery is equal to or less than the sum of the regenerative energy of the first battery and the regenerative energy of the second battery, the generator, the first battery, and the second battery are controlled so that the charging amount of the first battery is maintained as the target charging amount of the first battery, the charging amount of the second battery is maintained as the target charging amount of the second battery, and power of the first battery and power of the second battery are discharged to the electrical loads.

12. The method of claim 11, farther comprising calculating the required charging energy of the first battery by subtracting the current charging amount of the first battery from the target charging amount of the first battery and calculating the required charging energy of the second battery by subtracting the current charging amount of the second battery from the target charging amount of the second battery.

13. The method of claim 11, further comprising:
determining whether the road section in which the vehicle travels is a constant-speed travel section based on the predicted vehicle travel information and the vehicle position information when the sum of the required charging energy of the first battery and the required charging energy of the second battery exceeds the sum of the regenerative energy of the first battery and the regenerative energy of the second battery,
wherein when the road section in which the vehicle travels is the constant-speed travel section, an engine of the vehicle, the generator, which is connected to the engine, the first battery, and the second battery are controlled so that the charging amount of the first battery is the target charging amount of the first battery and the charging amount of the second battery is the target charging amount of the second battery.

14. The method of claim 13, wherein determining whether the road section in which the vehicle travels is a constant-speed travel section comprises determining that the road section in which the vehicle travels is the constant-speed travel section of the vehicle when a speed of the vehicle detected by a vehicle speed sensor of the vehicle is within a reference speed range and a variation value of an accelerator opening amount detected by an accelerator pedal detector of the vehicle is within a reference variation value range.

15. The method of claim 10, wherein the steps of calculating, estimating, determining, and controlling the generator and the first and second batteries are performed by a controller of the vehicle.

16. A method of controlling a generator for a vehicle, the method comprising:
calculating current charging amounts and target charging amounts of first and second batteries configured to supply power to a starter and electrical loads of the vehicle;
selecting the first battery or the second battery as a control battery to be controlled based on which battery has a small current charging amount;
estimating regenerative energy of the control battery based on predicted vehicle travel information;
determining whether a road section in which the vehicle travels is a regenerative braking section based on the predicted vehicle travel information and vehicle position information;
controlling the generator and the control battery so that the generator maximally charges the control battery when the road section in which the vehicle travels is the regenerative braking section; and
controlling the generator and the control battery based on required charging energy of the control battery and the regenerative energy of the control battery so that a charging amount of the control battery is the target charging amount of the control battery when the road section in which the vehicle travels is not the regenerative braking section.

17. The method of claim 16, further comprising determining whether the required charging energy of the control battery exceeds the regenerative energy of the control battery when the road section in which the vehicle travels is not the regenerative braking section, wherein when the required charging energy of the control battery is equal to or lower than the regenerative energy of the control battery, the generator and the control battery are controlled so that the charging amount of the control battery is maintained as the target charging amount of the control battery and power of the control battery is discharged to the electrical loads.

18. The method of claim 17, further comprising calculating the required charging energy of the control battery by subtracting the current charging amount of the control battery from the target charging amount of the control battery.

19. The method of claim 17, further comprising determining whether the road section in which the vehicle travels is a constant-speed travel section based on the predicted vehicle travel information and the vehicle position information when the required charging energy of the control battery exceeds the regenerative energy of the control battery, wherein when the road section in which the vehicle travels is the constant-speed travel section, an engine of the vehicle, the generator, which is connected to the engine, and the control battery are controlled so that the charging amount of the control battery is the target charging amount of the control battery.

20. The method of claim 19, wherein determining whether the road section in which the vehicle travels is a constant-speed travel section comprises determining that the road section in which the vehicle travels is the constant-speed travel section of the vehicle when a speed of the vehicle detected by a vehicle speed sensor of the vehicle is within a reference speed range and a variation value of an accelerator opening amount detected by an accelerator pedal detector of the vehicle is within a reference variation value range.
